(19) United States
(12) Patent Application Publication
(10) Pub. No.: US 2004/0089406 A1
(43) Pub. Date: May 13, 2004

(54) Method for producing an etching mask

(75) Inventors: Anton Buchner, Hagelstadt (DE); Alexander Heindl, Abensberg (DE)

Correspondence Address: COHEN, PONTANI, LIEBERMAN & PAVANE, 551 FIFTH AVENUE, SUITE 1210, NEW YORK, NY, 10176, US

(73) Assignee: Osram Opto Semiconductors GmbH, Regensburg (DE)

(21) Appl. No.: 10/466,122

(22) PCT Filed: Jan. 16, 2002
(86) PCT No.: PCT/DE02/00109

(30) Foreign Application Priority Data
Jan. 16, 2001 (DE) 101 01 734.0

(51) Int. Cl. B32B 3/04

(52) U.S. Cl. 156/216

(57) ABSTRACT

A photoresist layer (3) on the surface (2) of a substrate (1) is covered with a metalization layer (7) for the purpose of heating, so that an etching-stable photoresist layer with sharp structures is available after heating.

The invention relates to a method for forming an etching mask on a substrate, in which a photoresist layer is applied on a substrate and subsequently patterned.

Such methods are generally known. Usually, after the application of the photoresist layer, the latter is first exposed and then developed. The photoresist layer then covers those regions of the substrate which are not intended to be etched. Photoresist layers which are used for reactive ion etching must be made etching-stable before the etching step is carried out. To that end the photoresist is heated to high temperatures above the vitrification temperature of the photoresist.

One difficulty of the known method results from the fact that the photoresist becomes flowable during heating such that previously produced sharp-edged structures automatically become rounded. It is then no longer possible to etch exactly defined steep sidewalls into the substrate. Rather, only the rounded structures can be transferred into the substrate by etching.

Taking this prior art as a departure point, the underlying object of the invention is to specify a method for forming an etching mask which enables exactly defined, steep sidewalls to be etched in an underlying substrate.

This object is achieved by means of a method having the features of patent claim 1. Additional features of advantageous developments and embodiments and also preferred uses of the method are specified in the dependent claims.

In the method, a supporting layer, in particular a metalization layer, is applied to the photoresist layer before a heat treatment above the vitrification temperature, and only then is the photoresist layer subjected to thermal treatment.

The photoresist layer is stabilized by the supporting layer in such a way that, to the greatest extent possible, it does not become rounded during the above-described heat treatment step for etching stabilization. A thin supporting layer, preferably in the form of a thin metalization layer, supports the photoresist and prevents it from flowing. Therefore, an etching-stable etching mask with sharply pronounced structures results after the removal of the supporting layer.

The supporting layer preferably covers all free areas of the patterned photoresist layer.

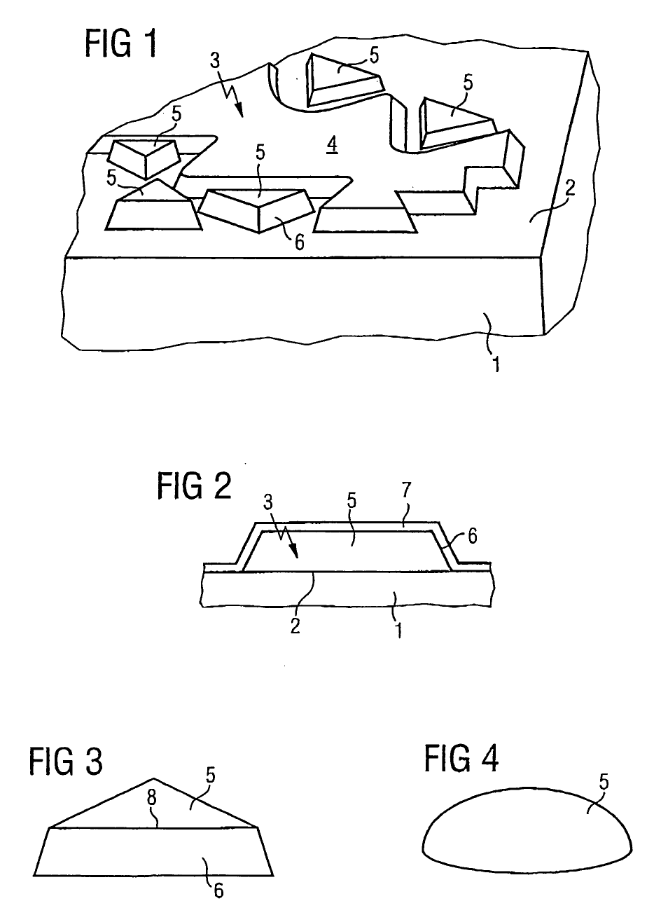

Further advantages and advantageous refinements of the method according to the invention emerge from the exemplary embodiments explained below in conjunction with FIGS. 1 to 4, in which:

FIG. 1 shows a diagrammatic illustration of a perspective view of a photoresist layer applied to a substrate;

FIG. 2 shows a diagrammatic illustration of a cross section through a section of the photoresist layer from FIG. 1;

FIG. 3 shows a diagrammatic illustration of an enlarged view of the photoresist layer from FIG. 1 after heating when employing the method according to the invention, and

FIG. 4 shows a diagrammatic illustration of an enlarged view of the photoresist layer from FIG. 1 after heating when employing a conventional method.

FIG. 1 shows a perspective view of a substrate 1 with a surface 2. The substrate 1 may be formed in a homogeneous manner or have a layer construction applied on a base or carrier substrate, for example, for optoelectronic structures such as radiation emitter structures.

In order to pattern the surface 2 of the substrate 1 by etching, in order, for example, to produce a radiation outcoupling structure on a radiation emitter layer sequence, a photoresist layer 3, produced for example from a commercially available positive resist, is applied on the surface 2. The photoresist layer 3 has contiguous tongues 4 and individual islands 5. The islands 5 are of truncated pyramid-shaped design and have beveled sidewalls 6. Such a structure is used, for example, preferably for patterned radiation outcoupling windows on light-emitting diode structures based on InₓGa_{y}Al_{1-x-y}P where 0≦x≦1, 0≦y≦1 and x+y≦1. Equally, such structures can also be used for producing topologically patterned active radiation emitter layer sequences based on InₓGa_{y}Al_{1-x-y}P where 0≦x≦1, 0≦y≦1 and x+y≦1 or InₓGa_{y}Al_{1-x-y}N where 0≦x≦1, 0≦y≦1 and x+y≦1. Furthermore, the method can be used for forming structures for integrated optical arrangements.

The structure of the photoresist layer 3 is transferred into the underlying substrate 2 with the aid of an anisotropic etching method such as RIE (Reactive Ion Etching). In this case, during the etching operation, the photoresist layer 3 is removed uniformly and its structure is thus transferred into the substrate.

In order to ensure the transfer of the structure of the photoresist layer 3 to the substrate, it is necessary that the photoresist layer 3 is etching-stable. This means that the form of the photoresist layer is permitted to change only in accordance with the uniform removal in the etching direction.

In order to ensure dimensional stability, that is to say such a uniform removal of the photoresist layer 3, the latter is subject to thermal treatment before etching above the vitrification temperature. This results in a particularly hard photoresist layer 3 which is etching-stable according to the definition as explained above even when an etching method such as reactive ion etching is employed.

In order to prevent the photoresist layer from flowing during the thermal treatment, a supporting layer 7, for example a metalization layer, is applied to the photoresist layer 3. The supporting layer 7 may be made of metal, such as, for example, Al, Pt, Ni or Au or metal oxide. Methods such as sputtering or vapor deposition are appropriate for applying the metalization layer 7. The thickness of the metalization layer 7 is expediently greater than 10 nm. Layer thicknesses of up to a thickness of 200 nm are also conceivable. However, the metalization layer 7 is then preferably applied in a stepwise manner because otherwise there is the risk of the photoresist layer 3 becoming too hot and softening.

After the application of the metalization layer 7, the photoresist layer 3 is subjected to thermal treatment. To that end, the photoresist layer 3 is heated to temperatures above the vitrification temperature of the photoresist. The vitrification temperatures for various photoresist layers 3 are known to the person skilled in the art and are therefore not explained in any further detail at this point. The photoresist layer 3 is usually heated to temperatures up to 200° C.

A particularly hard and stable photoresist layer 3 results after the cooling of the photoresist layer 3. The supporting layer 7 is subsequently removed by means of a suitable etching method. Such etching methods are known to the person skilled in the art, are not the subject matter of the application and are therefore not explained in any further detail at this point.

FIG. 3 shows an enlarged illustration of one of the islands 5 of the photoresist layer 3 after the removal of the supporting layer 7. It can be seen that the island 5 still has sharp edges and defined sidewalls 6. By contrast, FIG. 4 illustrates the originally same island 5 (that is to say the same island 5 directly after the patterning of the photoresist layer) after employing a conventional thermal treatment without a supporting layer 7. In this case, the island 5 only has the shape of a sphere segment after the conclusion of the thermal treatment method for the vitrification of the photoresist. The original truncated pyramid-shaped form of the island 5 no longer exists here.

Therefore, the method described here is suitable in particular for forming precise, defined structures in the surface 2 of the substrate 1.

The method according to the invention is described on the basis of a photoresist layer both in the general part of the description and in the exemplary embodiments. This does not mean, however, that this method is restricted to the use of photoresist. Rather, the method principle can basically be employed wherever an etching mask layer that is to be transferred into a substrate is liquefied after the patterning of said layer during an after-treatment and the previously produced structures would in the process be altered. In this respect, in the present case, the term “photoresist” encompasses not only photoresists per se, but also all other suitable etching mask materials with the properties set forth above.

1. A method for forming an etching mask on a substrate, in which a photoresist layer (3) is applied on a substrate (1) and patterned,
wherein
a supporting layer (7) is applied to the photoresist layer (3) and the photoresist layer (3) is subsequently subjected to thermal treatment at a temperature at which the photoresist of the photoresist layer is flowable, and wherein the supporting layer (7) is subsequently removed from the photoresist layer (3).

2. The method as claimed in claim 1,
wherein
the thickness of the supporting layer (7) is equal to or greater than 10 nm.

3. The method as claimed in claim 1 or 2,
wherein
the supporting layer (7) is applied to the photoresist layer (3) by sputtering.

4. The method as claimed in claim 1 or 2,
wherein
the supporting layer (7) is applied to the photoresist layer (3) by vapor deposition.

5. The method as claimed in one of claims 1 to 4,
wherein
the supporting layer (7) is produced from metal.

6. The method as claimed in claim 5,
wherein
the metal is selected from the group of elements Al, Pt, Ni, Au.

7. The method as claimed in one of claims 1 to 3,
wherein
the supporting layer (7) is produced from a metal oxide.

8. The method as claimed in one of claims 1 to 7,
wherein
the photoresist layer (3) is heated to a temperature above the vitrification temperature.

9. The method as claimed in one of claims 1 to 7,
wherein
the photoresist layer (3) is heated to a temperature below 200° C.

10. The method as claimed in one of claims 1 to 9,
wherein
the supporting layer (7) covers all free areas of the patterned photoresist layer.

11. The use of a method as claimed in one of claims 1 to 10, in a process for producing a patterned radiation outcoupling window on a light-emitting diode structure.

12. The use as claimed in claim 11 for a light-emitting diode structure based on InₓGa_{y}Al_{1-x-y}P where 0≦x≦1, 0≦y≦1 and x+y≦1 or based on InₓGa_{y}Al_{1-x-y}N where 0≦x≦1, 0≦y≦1 and x+y≦1.

13. The use of a method as claimed in one of claims 1 to 10 in a process for producing a topologically patterned active radiation emitter layer sequence based on InₓGa_{y}Al_{1-x-y}P where 0≦x≦1, 0≦y≦1 and x+y≦1 or based on InₓGa_{y}Al_{1-x-y}N where 0≦x≦1, 0≦y≦1 and x+y≦1.

14. The use of a method as claimed in one of claims 1 to 10 in a process for forming structures for an integrated optical arrangement.
